(19) United States
(12) Patent Application Publication
(10) Pub. No.: US 2014/0181541 A1
(43) Pub. Date: Jun. 26, 2014

(54) INFORMATION EQUIPMENT AND BATTERY CHARGE CIRCUIT

(71) Applicant: HITACHI, LTD., Tokyo (JP)

(72) Inventor: Teruhiko MATSUMOTO, Tokyo (JP)

(73) Assignee: HITACHI, LTD., Tokyo (JP)

(21) Appl. No.: 14/133,849

(22) Filed: Dec. 19, 2013

(30) Foreign Application Priority Data
Dec. 21, 2012 (JP) 2012-279291

(51) Int. Cl. H02J 7/00; G06F 1/30

(52) U.S. Cl. CPC H02J 7/0031; G06F 1/30
USPC 713/300; 320/107

(57) ABSTRACT

To protect a battery when an anomaly of a charge circuit occurs. Information equipment includes: a charge circuit for controlling an output voltage of a DC power supply and applying the controlled voltage to a battery; a battery protection circuit for interrupting a first power supply path connecting the battery and the charge circuit when an anomaly of the battery occurs; an input voltage detection circuit for detecting an input voltage which is input from the DC power supply to the charge circuit; and an interruption circuit for determining that an anomaly of the charge circuit has occurred, and interrupting a second power supply path connecting the first power supply path or the DC power supply and the charge circuit when the input voltage detected by the input voltage detection circuit fluctuates and indicates an abnormal value.

### TECHNICAL FIELD

The present invention relates to information equipment and battery charge circuit which are equipped with a chargeable battery.

### BACKGROUND ART

In recent years, power sources for information equipment, which are equipped with repeatedly-chargeable secondary batteries, have been increasing. Particularly, portability-focused equipment such as notebook-sized personal computers, tablet terminals, and mobile phones is equipped with a secondary battery. Moreover, even equipment that does not have to be moved is often equipped with a battery (secondary battery) as an uninterruptible power system. Such information equipment in which a secondary battery is mounted is generally equipped with a charge control circuit for charging the secondary battery.

As an example of the charge control circuit for charging the secondary battery, for example, suggested is a charge control circuit that performs switching control of a plurality of switching elements by a PWM (Pulse Width Modulation) control method and prevents a protection circuit for a battery pack from operating at a ripple voltage, which is an output voltage, when charging the battery pack including a lithium secondary battery by setting a switching frequency to 200 kHz at the time of constant current charge and setting the switching frequency to 400 kHz at a time close to the end of the constant current charge (see Patent Literature 1).

Moreover, while the secondary battery has the advantage of repeated chargeability as compared to a primary battery such as a dry battery, it requires special consideration with respect to its safety when used because it has an electric power storing function.

As an example of a charging apparatus having a protection function that protects a secondary battery, there is a charging apparatus equipped with a power supply interruption means for stopping a charge operation of a charge power circuit unit when an output voltage of a DC power supply deviates from an allowable voltage range, within which a main body of the charging apparatus can operate normally, during the process of application of electric power from the DC power supply to the secondary battery via the charge power circuit unit (see Patent Literature 2).

### CITATION LIST

### Patent Literature

[Patent Literature 1] Japanese Patent Application Laid-Open (Kokai) Publication No. 2012-80696
[Patent Literature 2] Japanese Patent Application Laid-Open (Kokai) Publication No. 2009-60683

### PROBLEMS TO BE SOLVED BY THE INVENTION

### Technical Problem

Meanwhile, if an anomaly occurs at the charge circuit for controlling the output voltage of the DC power supply, for example, in a case of the occurrence of a short fault causing short circuit of a switching element on a high-potential side among a plurality of switching elements constituting the charge circuit or in a case of the occurrence of a short fault causing short circuit of the input side and the output side of the charge circuit, the output voltage of the charge circuit cannot be controlled by switching control and the output voltage is applied as an over voltage to the battery (secondary battery). When this happens and if the DC power supply is equipped with an over current protection circuit, a maximum electric current that can be output by the DC power supply flows from the DC power supply to the battery when a short fault of the charge circuit occurs. If this electric current exceeds a threshold value of the over current protection circuit, the over current protection circuit operates, stops supplying the electric current from the DC power supply to the battery, and can protect the battery against the over current.

However, if the threshold value of the over current protection circuit is set to be a value larger than a value of the electric current flowing upon the occurrence of the short fault of the charge circuit depending on the type of the DC power supply, or if an electric current capacity that can be output from the DC power supply to the battery is low, or if a charge voltage of the battery is close to a rated voltage and is high, the electric current flowing from the DC power supply to the battery upon the occurrence of the short fault of the charge circuit may be low and may not exceed the threshold value of the over current protection circuit. In this case, even if the short fault occurs at the charge circuit, the over current protection circuit for the DC power supply does not operate, the electric current is supplied from the DC power supply to the battery, and the voltage of the battery gradually increases and may exceed the rated voltage. When this happens and a battery protection circuit for protecting the battery against an over voltage is placed in the battery, and if the voltage of the battery exceeds the rated voltage, a power supply path connecting the battery and the charge circuit is interrupted by an interruption operation of the battery protection circuit and application of the over voltage to the battery can be inhibited.

However, if the power supply path connecting the battery and the charge circuit is interrupted by the interruption operation of the battery protection circuit and the voltage of the battery becomes lower than the rated voltage, the interruption operation of the battery protection circuit stops and a power supply path connecting the battery and the charge circuit is formed. When this power supply path is formed, the electric current is supplied from the DC power supply to the battery, the voltage of the battery becomes high again, and the voltage of the battery then exceeds the rated voltage. In this case, the power supply path connecting the battery and the charge circuit is interrupted again by the interruption operation of the battery protection circuit. Subsequently, the interruption operation of the battery protection circuit is performed and then stopped repeatedly. Therefore, if the interruption operation of the battery protection circuit is performed and then stopped repeatedly for a long period of time, a voltage close to an overcharge state is always applied to a cell constituting the battery and there is fear that the cell in the battery may deteriorate.

The present invention was devised in light of the problems of the conventional art and it is an object of the invention to provide information equipment and battery charge circuit which are capable of protecting a battery upon the occurrence of an anomaly of a charge circuit.

### Means for Solving the Problems

In order to solve the above-described problems, the present invention is characterized in that it includes: a charge circuit located between a DC power supply and a battery, for controlling an output voltage of the DC power supply and applying the controlled voltage to the battery; a battery protection circuit for interrupting a first power supply path connecting the battery and the charge circuit when an anomaly of the battery occurs; an input voltage detection circuit for detecting an input voltage which is input from the DC power supply to the charge circuit; and an interruption circuit for determining that an anomaly of the charge circuit has occurred, and interrupting a second power supply path connecting the first power supply path or the DC power supply and the charge circuit when the input voltage detected by the input voltage detection circuit fluctuates and indicates an abnormal value.

### Advantageous Effects of Invention

According to the present invention, the battery can be protected when an anomaly of the charge circuit occurs.

### BRIEF DESCRIPTION OF DRAWINGS

FIG. 1 is a configuration diagram of information equipment according to a first embodiment of the present invention.

FIG. 2 is a characteristic diagram illustrating voltage-current characteristics of a battery under constant current charge control and constant voltage charge control by a charge control unit.

FIG. 3 is a characteristic diagram illustrating voltage-current characteristics of the battery under constant current charge control and pulse charge control by the charge control unit.

FIG. 4 is a characteristic diagram for explaining changes in the current and the voltage of the battery when an over current protection circuit operates upon the occurrence of a short fault of a charge circuit.

FIG. 5 is a characteristic diagram for explaining changes in the current and the voltage of the battery when the over current protection circuit becomes inoperable upon the occurrence of a short fault of the charge circuit.

FIG. 6 is a characteristic diagram for explaining changes in the voltage of the battery and the input voltage of the charge circuit when the over current protection circuit becomes inoperable upon the occurrence of a short fault of the charge circuit.

FIG. 7 is a flowchart for explaining processing of a microcomputer according to a first embodiment of the present invention.

FIG. 8 is a flowchart for explaining processing of the microcomputer according to a second embodiment of the present invention.

FIG. 9 is a configuration diagram of information equipment according to a third embodiment of the present invention.

FIG. 10 is a characteristic diagram for explaining changes in the input voltage of the charge circuit in association with voltage fluctuations of the DC power supply.

FIG. 11 is a characteristic diagram for explaining the relationship between voltage fluctuations in association with an anomaly of the charge circuit and voltage fluctuations of the DC power supply itself.

FIG. 12 is a flowchart for explaining processing of the microcomputer according to the third embodiment of the present invention.

FIG. 13 is a configuration diagram of information equipment according to a fourth embodiment of the present invention.

FIG. 14 is a configuration diagram of information equipment according to a fifth embodiment of the present invention.

### DESCRIPTION OF EMBODIMENTS

An embodiment of the present invention will be explained with reference to drawings.

### First Embodiment

This embodiment is designed to determine that an anomaly has occurred at a charge circuit on condition that an input voltage of the charge circuit fluctuates up and down or in a pulsed manner once.

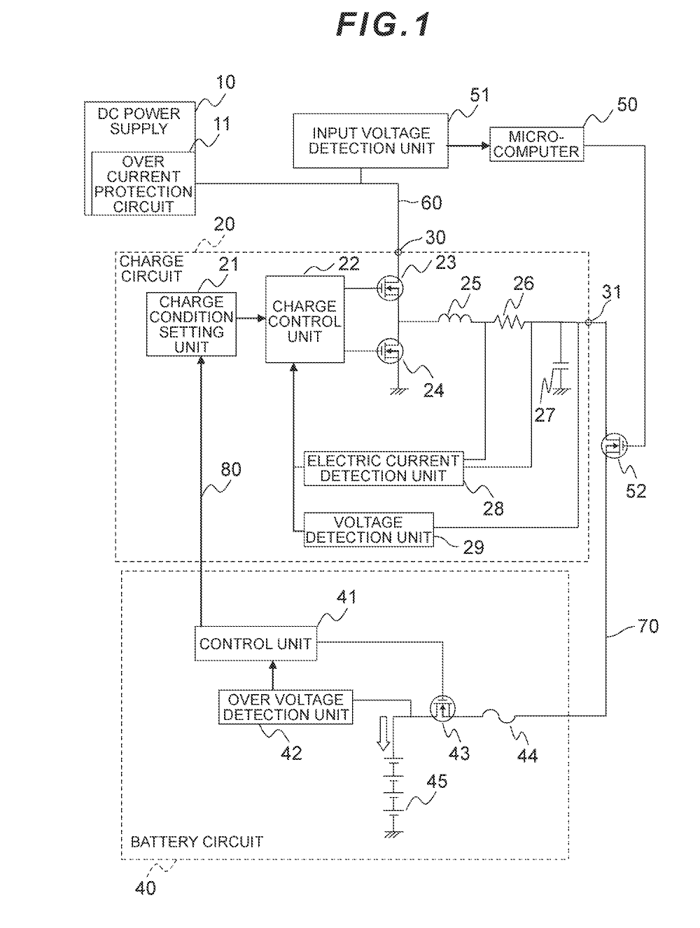

FIG. 1 is a configuration diagram of information equipment according to a first embodiment of the present invention. Referring to FIG. 1, the information equipment includes a DC power supply 10, a charge circuit 20, a battery circuit 40 containing a battery 45, and a microcomputer 50; and the microcomputer 50 is composed of, for example, a personal computer. Incidentally, a tablet terminal or a mobile phone can be used instead of the microcomputer 50.

The DC power supply 10 includes a power converter (not shown) for converting an alternating-current power to a direct-current power and an over current protection circuit 11; and a direct-current output side of the power converter is connected to the charge circuit 20. An output voltage of the DC power supply 10 is set to be higher than a rated voltage of the battery 45 in order to enhance electric power conversion efficiency. If the electric current supplied from the DC power supply 10 to the charge circuit 20 exceeds a threshold value, the over current protection circuit 11 has a function that interrupts a power supply path 60 connecting the DC power supply 10 and the charge circuit 20 and stops supplying the electric current to the charge circuit 20.

The charge circuit 20 includes a charge condition setting unit 21, a charge control unit 22, a high-side N channel MOS-FET 23, a low-side N channel MOS-FET 24, a choke coil 25, a resistance 26, a smoothing capacitor 27, an electric current detection unit 28, and a voltage detection unit 29. The high-side N channel MOS-FET 23 and the low-side N channel MOS-FET 24 are connected to each other serially and are inserted into between a power supply input terminal 30 and the ground. One end of the choke coil 25 is connected to between the high-side N channel MOS-FET 23 and the low-side N channel MOS-FET 24 and the other end of the choke coil 25 is connected via the resistance 26 to one end of the smoothing capacitor 27 and the power supply output terminal 31. The power supply input terminal 30 is connected via the power supply path 60 to the DC power supply 10 and the power supply output terminal 31 is connected via a power supply path 70 to the battery circuit 40.

The electric current detection unit 28 converts a voltage at both ends of the resistance 26 into an electric current, detects the electric current flowing through the resistance 26, and feeds back the detected electric current to the charge control unit 22. The voltage detection unit 29 detects a voltage of the power supply output terminal 31 and feeds back the detected voltage to the charge control unit 22.

If the charge condition setting unit 21 stores set values of a charge voltage and a charge current, it outputs information indicating the set values of the charge voltage and the charge current to the charge control unit 22; and if the charge condition setting unit 21 obtains battery information from the battery circuit 40 via a battery information acquisition bus 80, it outputs the obtained battery information to the charge control unit 22.

The charge control unit 22 compares information input from the charge condition setting unit 21 with information fed back from the electric current detection unit 28 and the voltage detection unit 29, respectively, generates a switching control signal, which always matches charge conditions, and performs switching control of the high-side N channel MOS-FET 23 and the low-side N channel MOS-FET 24 in accordance with the generated switching control signal. Under this circumstance, an input voltage to the charge circuit 20 can be converted into a charge voltage and charge current which match the charge conditions of the battery 45, and the converted charge voltage and charge current can then be output by controlling an ON/OFF duty ratio of the high-side N channel MOS-FET 23 and the low-side N channel MOS-FET 24. Furthermore, if the electric current detected by the electric current detection unit 28 is an over current or if the voltage detected by the voltage detection unit 29 is an over voltage, the charge control unit 22 stops the operation of the high-side N channel MOS-FET 23 and the low-side N channel MOS-FET 24 and interrupts the output to the battery circuit 40.

The battery circuit 40 includes a control unit 41, an over voltage detection unit 42, an N channel MOS-FET 43, a fuse 44, and a battery 45 including a cell. The battery 45 is composed of a repeatedly-chargeable secondary battery such as a secondary battery which uses lithium ions. The N channel MOS-FET 43 and the fuse 44 are connected to each other serially and are inserted into the power supply path 70 connecting the battery 45 and the charge circuit 20. If an over voltage is applied to the voltage at both ends of the battery 45, the over voltage detection unit 42 outputs an over voltage detection signal to the control unit 41.

The control unit 41 outputs the battery information indicating the charge conditions of the battery 45 to the charge condition setting unit 21 via the bus 80; and if the voltage at both ends of the battery 45 is equal to or lower than a rated voltage, the control unit 41 turns on the N channel MOS-FET 43, forms the power supply path 70, and supplies the electric current from the charge circuit 20 to the battery 45. On the other hand, if the over voltage detection signal is input from the over voltage detection unit 42, the control unit 41 turns off the N channel MOS-FET 43, interrupts the power supply path 70, and stops supplying the electric current from the charge circuit 20 to the battery 45. Specifically speaking, the control unit 41, the over voltage detection unit 42, and the N channel MOS-FET 43 function as a battery protection circuit for protecting the battery 45 against an over voltage when an anomaly of the battery 45 occurs. When an anomaly of the battery 45 occurs under this circumstance, the battery protection circuit interrupts the power supply path 70; and if the battery 45 then returns to a normal state, the N channel MOS-FET 43 turns on and constitutes a resettable protection circuit which forms the power supply path 70.

The microcomputer 50 is a computer device equipped with information processing resources such as a CPU (Central Processing Unit), a memory, and an input/output interface and constitutes an information processing circuit for processing information and an interruption circuit; and the input voltage detection unit 51 and the N channel MOS-FET 52 are connected to the input/output interface. The input voltage detection unit 51 detects the voltage of the power supply path 60, that is, the input voltage of the charge circuit 20 and outputs the detected voltage to the microcomputer 50. The N channel MOS-FET 52 is inserted into the power supply path 70 connecting the charge circuit 20 and the battery circuit 40; and if the charge circuit 20 is in a normal state, the N channel MOS-FET 52 is turned on by a control signal from the microcomputer 50 and then forms the power supply path 70. The microcomputer 50 monitors the voltage detected by the input voltage detection unit 51; and if the voltage detected by the input voltage detection unit 51 fluctuates up and down or in a pulsed manner in association with an anomaly of the charge circuit 20 and a value of the fluctuating voltage indicates an abnormal value, for example, if an amplitude value of the fluctuating voltage deviates from a specified value, the microcomputer 50 functions as an interruption circuit for turning off the N channel MOS-FET 52 and interrupting the power supply path 70.

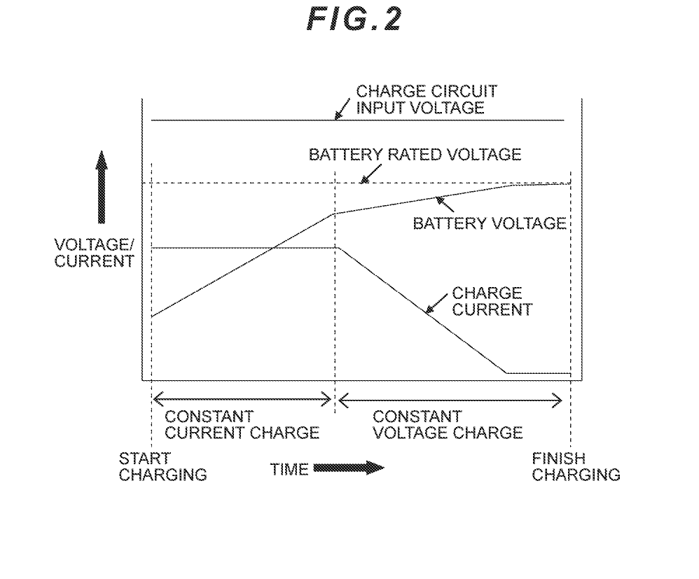

FIG. 2 is a characteristic diagram illustrating voltage-current characteristics of the battery under constant current charge control and constant voltage charge control by the charge control unit.

Referring to FIG. 2, if the charge control unit 22 performs the constant current charge control when controlling the ON/OFF duty ratio of the high-side N channel MOS-FET 23 and the low-side N channel MOS-FET 24, a constant charge current is supplied from the charge circuit 20 to the battery 45; and if the charge control unit 22 then performs the constant voltage charge control, the charge current which gradually decreases is supplied from the charge circuit 20 to the battery 45. Meanwhile, the voltage of the battery 45 gradually increases. When the battery 45 enters a fully-charged state, the voltage of the battery 45 is maintained to be a battery rated voltage and charging of the battery 45 is terminated. Incidentally, while the constant current charge control and the constant voltage charge control are performed, the input voltage of the charge circuit 20 (charge circuit input voltage) is maintained to be a constant value.

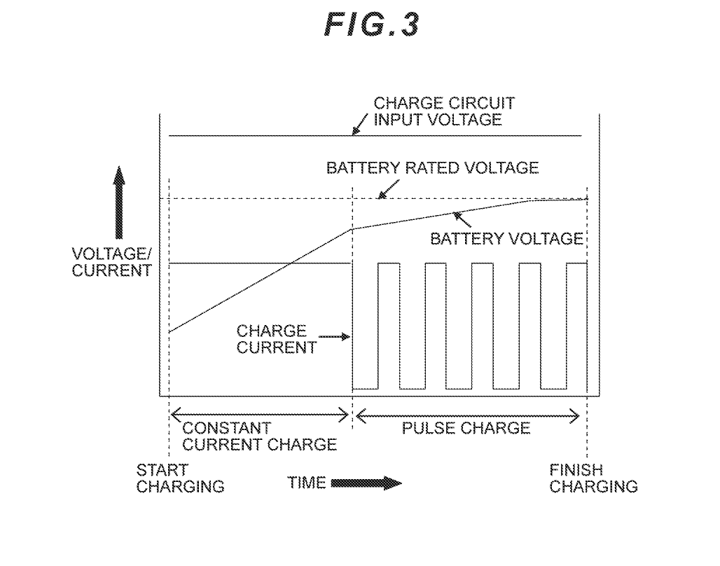

FIG. 3 is a characteristic diagram illustrating voltage-current characteristics of the battery under the constant current charge control and the pulse charge control by the charge control unit.

Referring to FIG. 3, if the charge control unit 22 performs the constant current charge control when controlling the ON/OFF duty ratio of the high-side N channel MOS-FET 23 and the low-side N channel MOS-FET 24, a constant charge current is supplied from the charge circuit 20 to the battery 45; and if the charge control unit 22 then performs the pulse charge control, a pulsed charge current is supplied from the charge circuit 20 to the battery 45. Meanwhile, the voltage of the battery 45 gradually increases. When the battery 45 enters a fully-charged state, the voltage of the battery 45 is maintained to be a rated voltage and charging of the battery 45 is terminated. Since the electric current which is larger than that of the constant voltage charge control can be applied to the battery 45 by executing the pulse charge control when the voltage of the battery 45 becomes close to the rated voltage, it is possible to shorten time required for the battery 45 to enter the fully-charged state. Incidentally, while the constant current charge control and the pulse charge control are performed, the input voltage of the charge circuit 20 (charge circuit input voltage) is maintained to be a constant value.

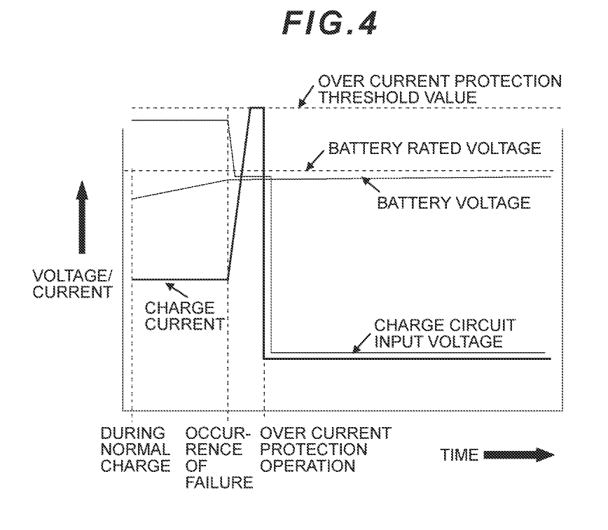

FIG. 4 is a characteristic diagram for explaining changes in the electric current and the voltage of the battery when the over current protection circuit operates upon the occurrence of a short fault of the charge circuit. Referring to FIG. 4, if a short fault occurs at both ends of the high-side N channel MOS-FET 23 (between a drain and source of the high-side N channel MOS-FET 23) in the charge circuit 20, the power supply input terminal 30 and the choke coil 25 are connected directly and the charge current to the battery 45 increases rapidly. If this charge current exceeds an over current protection threshold value which is set to the over current protection circuit 11 for the DC power supply 10, the power supply path 60 is interrupted by the operation of the over current protection circuit 11 and the input voltage to the charge circuit 20 (the charge circuit input voltage) and the charge current to the battery 45 decrease rapidly, so that the battery 45 can be protected against the over current. Incidentally, the voltage of the battery 45 is maintained to be a value lower than the battery rated voltage.

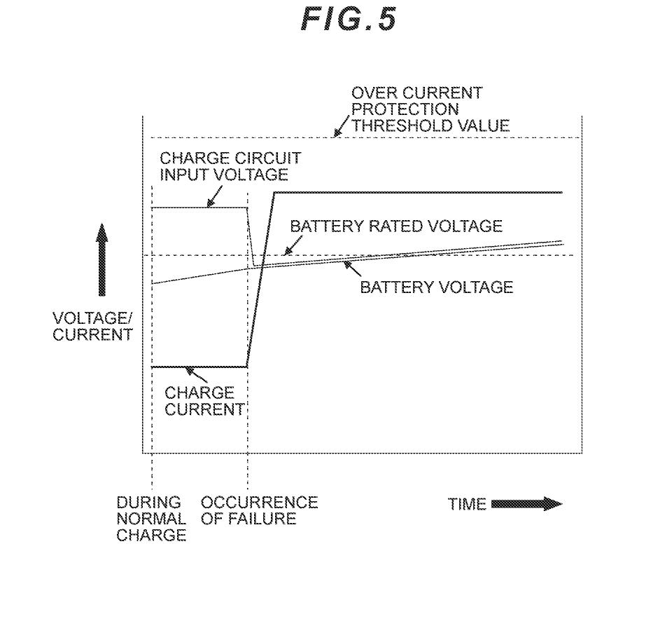

FIG. 5 is a characteristic diagram for explaining changes in the electric current and the voltage of the battery when the over current protection circuit becomes inoperable when a short fault of the charge circuit has occurred. Referring to FIG. 5, if a short fault occurs at both ends of the high-side N channel MOS-FET 23 in the charge circuit 20, the power supply input terminal 30 and the choke coil 25 are connected directly and the charge current to the battery 45 increases rapidly. Under this circumstance, if the over current protection threshold value of the over current protection circuit 11 is set to be a value larger than the value of the electric current passing upon the occurrence of the short fault of the charge circuit 20 depending on the type of the DC power supply 10, or if an electric current capacity that can be output from the DC power supply 10 to the battery 45 is low, or if the charge voltage of the battery 45 is high, the electric current flowing from the DC power supply 10 to the battery 45 upon the occurrence of the short fault of the charge circuit 20 may be low and may not exceed the over current protection threshold value of the over current protection circuit 11.

In this case, even if the short fault occurs at the charge circuit 20, the over current protection circuit 11 for the DC power supply 10 does not operate, the electric current is supplied from the DC power supply 10 to the battery 45, the voltage of the battery 45 gradually increases, and the voltage of the battery 45 may exceed the battery rated voltage.

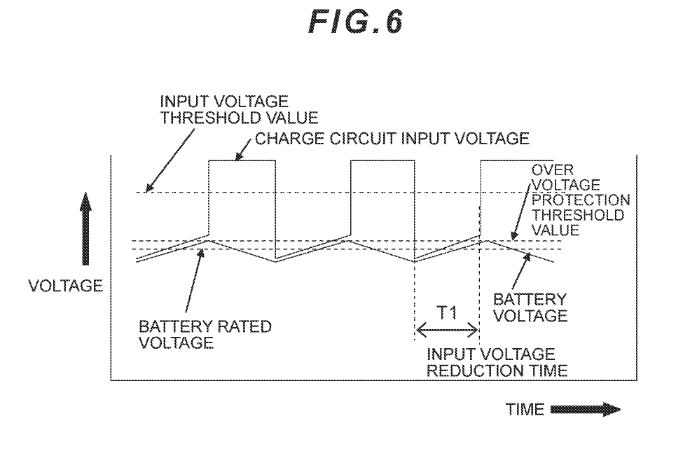

FIG. 6 is a characteristic diagram for explaining changes in the voltage of the battery and the input voltage of the charge circuit when the over current protection circuit becomes inoperable upon the occurrence of a short fault of the charge circuit. Referring to FIG. 6, even if a short fault occurs at both ends of the high-side N channel MOS-FET 23 in the charge circuit 20, if the electric current flowing from the DC power supply 10 to the battery 45 is low and does not exceed an over current protection threshold value of the over current protection circuit 11, the over current protection circuit 11 for the DC power supply 10 does not operate even upon the occurrence of the short fault at the charge circuit 20, the electric current is supplied from the DC power supply 10 to the battery 45 and the voltage of the battery 45 gradually increases.

If the voltage of the battery 45 exceeds the battery rated voltage under this circumstance, the over voltage detection unit 42 detects the over voltage. If the over voltage detected by the over voltage detection unit 42 exceeds an over voltage protection threshold value, the control unit 41 turns off the N channel MOS-FET 43. Consequently, the power supply path 70 is interrupted. If the power supply path 70 is interrupted, the electric current will no longer flow from the DC power supply 10 to the battery 45. So, the input voltage of the charge circuit 20 (the charge current input voltage) will increase rapidly to the output voltage of the DC power supply 10 and exceed the input voltage threshold value.

On the other hand, if the power supply path 70 is interrupted, the electric current will no longer flow from the DC power supply 10 to the battery 45. So, the voltage of the battery 45 will gradually decrease and become lower than the battery rated voltage. When the voltage of the battery 45 becomes lower than the battery rated voltage, the over voltage detected by the over voltage detection unit 42 becomes lower than the over voltage protection threshold value. The control unit 41 turns on the N channel MOS-FET 43 again on condition that the over voltage detected by the over voltage detection unit 42 becomes lower than the over voltage protection threshold value. In this case, the power supply path 70 is formed on condition that the microcomputer 50 does not turn off the N channel MOS-FET 52.

Once the power supply path 70 is formed, the electric current is supplied from the DC power supply 10 to the battery 45, the input voltage of the charge circuit 20 becomes lower than the battery rated voltage of the battery 45 and then gradually increases, and the voltage of the battery 45 gradually increases. When the voltage of the battery 45 exceeds the battery rated voltage and the over voltage detected by the over voltage detection unit 42 exceeds the over voltage protection threshold value, the N channel MOS-FET 43 is tuned off and the power supply path 70 is interrupted. Once the power supply path 70 is interrupted, the input voltage of the charge circuit 20 (charge circuit input voltage) increases rapidly to the output voltage of the DC power supply 10 and then exceeds the input voltage threshold value. On the other hand, the voltage of the battery 45 gradually decreases and then becomes lower than the battery rated voltage. When the voltage of the battery 45 becomes lower than the battery rated voltage and the over voltage detected by the over voltage detection unit 42 becomes lower than the over voltage protection threshold value, the N channel MOS-FET 43 is turned on and the power supply path 70 is formed.

If the microcomputer 50 does not turn off the N channel MOS-FET 52 even if a short fault has occurred at the charge circuit 20, the interruption operation of the over voltage protection circuit is performed and then stopped repeatedly and the input voltage of the charge circuit 20 fluctuates up and down in constant cycles. If these voltage fluctuations are repeated for a long period, the voltage close to an overcharge state is always applied to the cell constituting the battery 45 and there is fear that the cell in the battery 45 may deteriorate.

Then, in this embodiment, the input voltage detection unit 51 detects the input voltage of the charge circuit 20 and outputs the detected voltage to the microcomputer 50 and the microcomputer 50 judges whether an anomaly of the input voltage of the charge circuit 20 has occurred or not; and if the microcomputer 50 determines that the anomaly has occurred, it turns off the N channel MOS-FET 52 and interrupts the power supply path 70. Under this circumstance, if the input voltage of the charge circuit 20 fluctuates up and down and the value of the fluctuating voltage indicates an abnormal value, the microcomputer 50 turns off the N channel MOS-FET 52 and interrupts the power supply path 70.

If the N channel MOS-FET 52 is turned off and the power supply path 70 is interrupted upon the occurrence of the short fault of the charge circuit 20, the electric current will not be supplied from the DC power supply 10 to the battery 45 even if the N channel MOS-FET 43 for the battery circuit 40, which is on, is turned off and then turned on again. So, it is possible to prevent the voltage of the battery 45 from exceeding the battery rated voltage and also prevent the input voltage of the charge circuit 20 from fluctuating up and down in cycles.

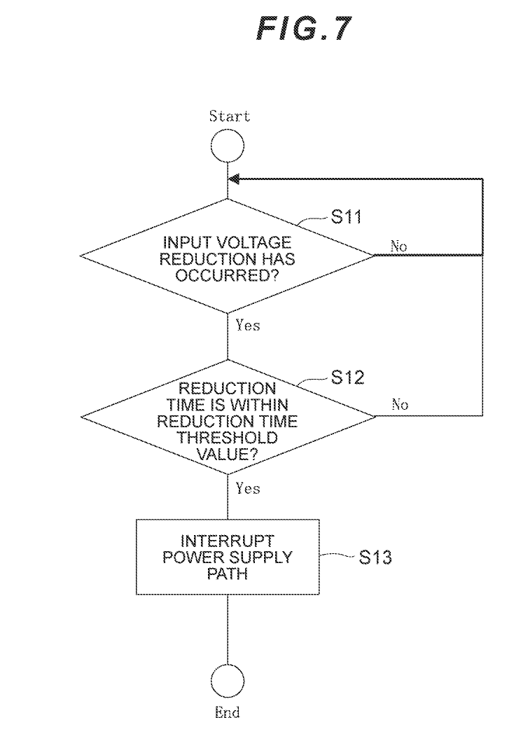

FIG. 7 is a flowchart for explaining processing of the microcomputer according to the first embodiment of the present invention. This processing is executed by the CPU contained in the microcomputer 50. The microcomputer 50 inputs the voltage detected by the input voltage detection unit 51 from the input voltage detection unit 51 and judges whether the input voltage of the charge circuit 20 has decreased or not (S11). If the microcomputer 50 obtains a negative judgment result in step S11, it repeats the processing in step S11; and if the microcomputer 50 obtains an affirmative judgment result in step S11, it judges whether reduction time T1 of the input voltage of the charge circuit 20 (see the input voltage reduction time T1 in FIG. 6) is within a reduction time threshold value or not (S12). Specifically speaking, the microcomputer 50 judges whether a period of time from the time when the N channel MOS-FET 43 for the battery circuit 40, which is on, is turned off until the time when the N channel MOS-FET 43 is turned on is within the reduction time threshold value or not.

If the microcomputer 50 obtains a negative judgment result in step S12, it repeats the processing in steps S11 and S12; and if the microcomputer 50 obtains an affirmative judgment result in step S12, that is, if the input voltage of the charge circuit 20 fluctuates up and down or in a pulsed manner once, it is determined that an anomaly such as a short fault has occurred at the charge circuit 20, then the microcomputer 50 turns off the N channel MOS-FET 52 and interrupts the power supply path 70 (S13), thereby terminating the processing in this routine.

In this embodiment, when a short fault has occurred at the charge circuit 20, for example, when a short fault which causes both ends of the N channel MOS-FET 23 to be connected has occurred, or when a short fault which causes short circuit of the power supply input terminal 30 and the power supply output terminal 31 has occurred, the N channel MOS-FET 52 is turned off and the power supply path 70 is interrupted even if the input voltage of the charge circuit 20 fluctuates up and down or in a pulsed manner once, and condition that the reduction time T1 of the input voltage of the charge circuit 20 is within the reduction time threshold value. Incidentally, the reduction time threshold value is set to be shorter than time during which the output voltage of the DC power supply 10 decreases in association with attachment or detachment of the DC power supply 10.

According to this embodiment, it is possible to prevent the voltage of the battery 45 from exceeding the rated voltage and also prevent the input voltage of the charge circuit 20 from fluctuating up and down or in a pulsed manner more than once; and as a result, it is possible to protect the battery 45 when an anomaly of the charge circuit 20 has occurred. Furthermore, the power supply path 70 is interrupted on condition that the reduction time T1 of the input voltage of the charge circuit 20 is within the reduction time threshold value. So, it is possible to prevent the power supply path 70 from being mistakenly interrupted when the input voltage decreases in association with the attachment or detachment of the DC power supply 10.

### Second Embodiment

This embodiment is designed to determine that an anomaly has occurred at the charge circuit 20 on condition that the input voltage of the charge circuit 20 fluctuates up and down or in a pulsed manner a specified number of times or more; and the configuration of the information equipment is the same as that of the first embodiment

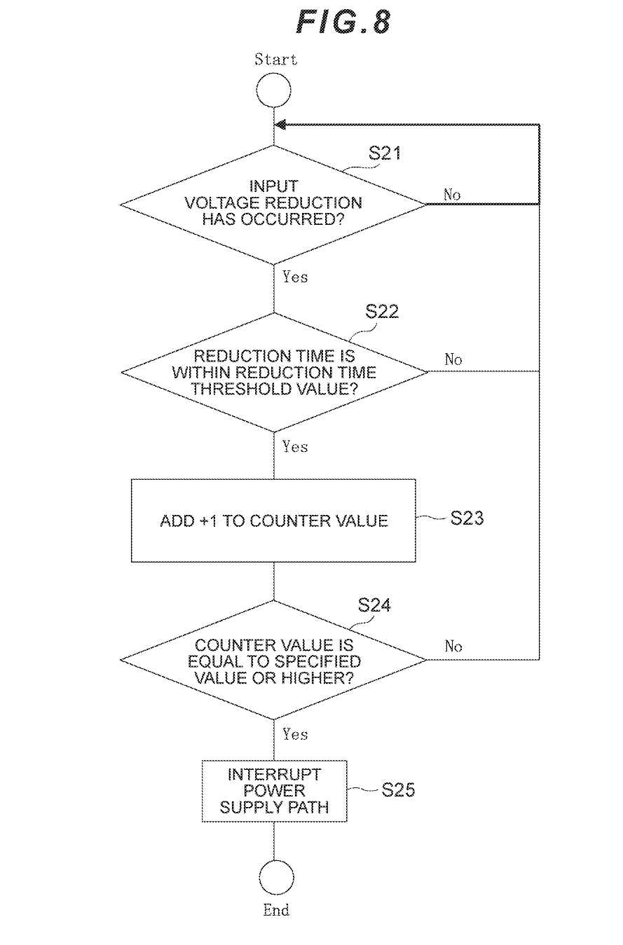

FIG. 8 is a flowchart for explaining processing of the microcomputer according to a second embodiment of the present invention. This processing is executed by the CPU contained in the microcomputer 50. The microcomputer 50 inputs the voltage detected by the input voltage detection unit 51 from the input voltage detection unit 51 and judges whether the input voltage of the charge circuit 20 has decreased or not (S21). If the microcomputer 50 obtains a negative judgment result in step S21, it repeats the processing in step S21; and if the microcomputer 50 obtains an affirmative judgment result in step S21, it judges whether the reduction time T1 of the input voltage of the charge circuit 20 (see the input voltage reduction time T1 in FIG. 6) is within a reduction time threshold value or not (S22).

If the microcomputer 50 obtains a negative judgment result in step S12, it repeats the processing in steps S21 and S22; and if the microcomputer 50 obtains an affirmative judgment result in step S22, that is, if the input voltage of the charge circuit 20 fluctuates up and down or in a pulsed manner once, the microcomputer 50 determines that an anomaly such as a short fault has occurred at the charge circuit 20, and then adds +1 to a counter value (S23).

Next, the microcomputer 50 judges whether or not the counter value is equal to or more than a specified value (an integer equal to or more than 2) (S24); and if the microcomputer 50 determines that the counter value is less than the specified value, it returns to the processing in step S21 and repeats the processing in steps S21 to S24; and if the microcomputer 50 determines that the counter value is equal to or more than the specified value, that is, if the input voltage of the charge circuit 20 fluctuates up and down or in a pulsed manner a specified number of times or more, it turns off the N channel MOS-FET 52 and interrupts the power supply path 70 (S13), thereby terminating the processing in this routine. Specifically speaking, on condition that the input voltage of the charge circuit 20 fluctuates up and down or in a pulsed manner the specified number of times or more, the microcomputer 50 determines that an anomaly associated with a short fault has occurred at the charge circuit 20; and then the microcomputer 50 turns off the N channel MOS-FET 52 and interrupts the power supply path 70.

In this embodiment, when a short fault has occurred at the charge circuit 20, for example, when a short fault which causes both ends of the N channel MOS-FET 23 to be connected has occurred, or when a short fault which causes short circuit of the power supply input terminal 30 and the power supply output terminal 31 has occurred, the N channel MOS-FET 52 is turned off and the power supply path 70 is interrupted even if the input voltage of the charge circuit 20 fluctuates, and on condition that the reduction time T1 of the input voltage of the charge circuit 20 is within the reduction time threshold value and the counter value is equal to or more than the specified value.

According to this embodiment, it is possible to prevent the voltage of the battery 45 from exceeding the rated voltage and also prevent the input voltage of the charge circuit 20 from fluctuating up and down or in a pulsed manner more than the specified number of times; and as a result, it is possible to protect the battery 45 when an anomaly of the charge circuit 20 has occurred. Furthermore, the power supply path 70 is interrupted on condition that the input voltage of the charge circuit 20 fluctuates up and down or in a pulsed manner the specified number of times or more. So, it is possible to prevent the power supply path 70 from being interrupted due to accidental voltage fluctuations.

### Third Embodiment

This embodiment is designed so that the charge condition setting unit 21 for the charge circuit 20 and the microcomputer 50 are connected via a charge condition acquisition bus 90 and the microcomputer 50 judges whether an anomaly of the charge circuit 20 has occurred or not based on charge conditions obtained via the charge condition acquisition bus 90.

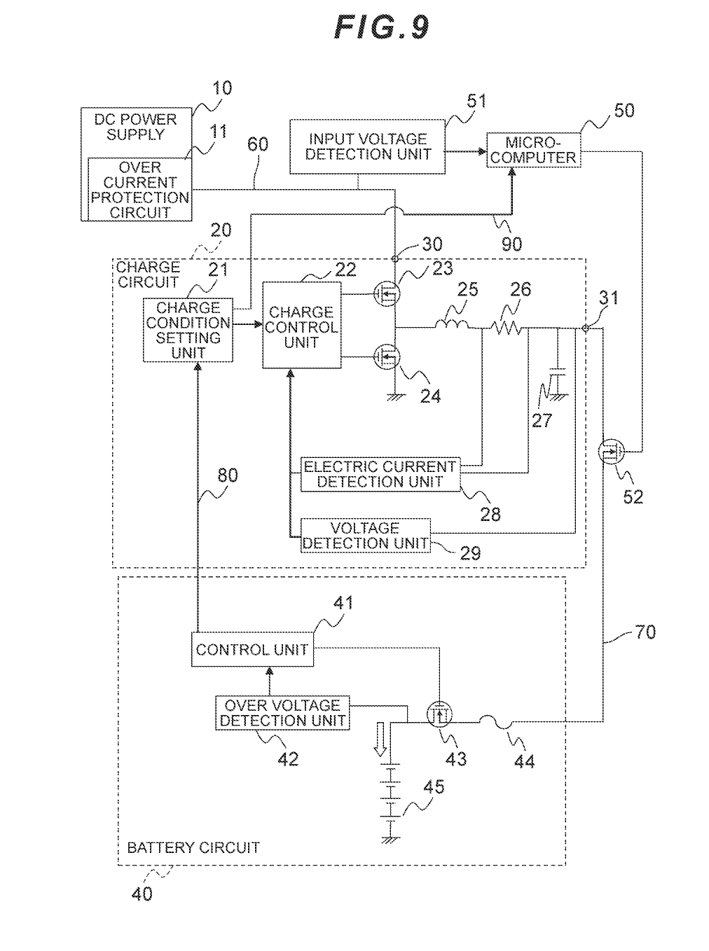

FIG. 9 is a configuration diagram of information equipment according to a third embodiment of the present invention. Referring to FIG. 9, the information equipment according to this embodiment is designed so that the charge condition setting unit 21 for the charge circuit 20 and the microcomputer 50 are connected via the charge condition acquisition bus 90 and the microcomputer 50 judges whether an anomaly has occurred at the charge circuit 20 or not, based on the charge conditions obtained via the charge condition acquisition bus 90; and other components are the same as those of the first embodiment.

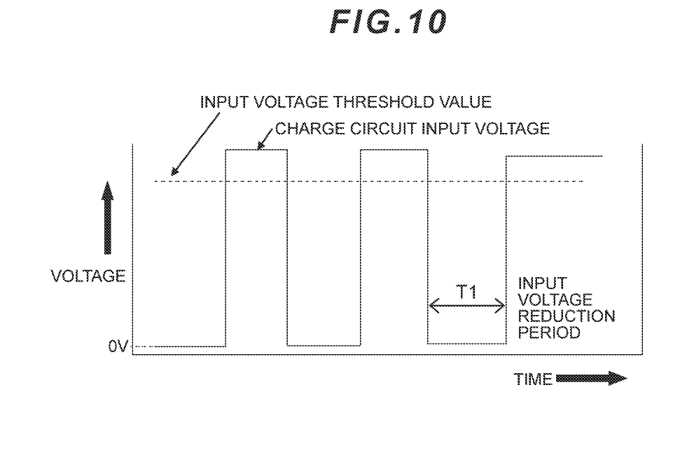

FIG. 10 is a characteristic diagram for explaining changes in the input voltage of the charge circuit in association with voltage fluctuations of the DC power supply. Referring to FIG. 10, even if the charge circuit 20 is normal, the input voltage of the charge circuit 20 may fluctuate if the voltage of the DC power supply 10 itself fluctuates. For example, if noise arises from within the DC power supply 10 or a contact failure occurs in electrical components within the DC power supply 10 due to the usage environment, the output voltage of the DC power supply 10 may fluctuate and the input voltage of the charge circuit 20 may change to a pulsed state and exceed a threshold value. In this case, the microcomputer 50 according to the first embodiment interrupts the power supply path 70 on condition that the input voltage of the charge circuit 20 fluctuates in a pulsed manner once and the reduction time T1 of the input voltage of the charge circuit 20 is within the reduction time threshold value.

Specifically speaking, the reduction time threshold value is set to a level of several seconds in consideration of a time interval for attachment or detachment of the DC power supply 10. So, if a cycle of voltage fluctuations of the DC power supply 10 itself is less than the reduction time threshold value, the microcomputer 50 will interrupt the power supply path 70 even if the charge circuit 20 is normal. Accordingly, the power supply path 70 may be interrupted mistakenly due to the voltage fluctuations of the DC power supply 10 itself merely by judging whether the reduction time of the input voltage of the charge circuit 20 is within the reduction time threshold value or not. Therefore, it is necessary to prevent the power supply path 70 from being mistakenly interrupted due to the voltage fluctuations of the DC power supply 10 itself.

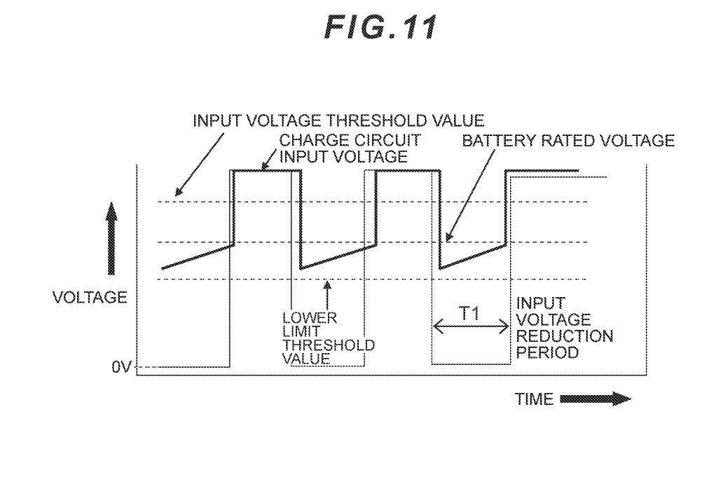

FIG. 11 is a characteristic diagram for explaining the relationship between voltage fluctuations in association with an anomaly of the charge circuit and voltage fluctuations of the DC power supply itself. Referring to FIG. 11, if the input voltage of the charge circuit 20 changes to a pulsed state in association with a short fault of the charge circuit 20, this input voltage changes between a voltage, which is lower than the battery rated voltage of the battery 45 and slightly higher than a lower limit threshold value, and a voltage which is higher than the battery rated voltage of the battery 45 and higher than an input voltage threshold value. If the input voltage of the charge circuit 20 changes to the pulsed state in association with the short fault of the charge circuit 20, the input voltage of the charge circuit 20, which reduces during the reduction time T1 of the input voltage of the charge circuit 20, becomes a voltage higher than the lower limit threshold value.

On the other hand, if the input voltage of the charge circuit 20 changes to the pulsed state due to the voltage fluctuations of the DC power supply 10 itself, this input voltage changes between a voltage of 0 volt and a voltage which is higher than the battery rated voltage of the battery 45 and higher than the input voltage threshold value. In this case, the input voltage of the charge circuit 20, which reduces during the reduction time T1 of the input voltage of the charge circuit 20, is the voltage of 0 volt.

Specifically, when the input voltage of the charge circuit 20 changes to the pulsed state, and if the reduction time T1 of the input voltage of the charge circuit 20 is within the reduction time threshold value and the input voltage of the charge circuit 20 is higher than the lower limit threshold value, it is possible to determine that the voltage fluctuations have occurred in association with an anomaly of the charge circuit 20. On the other hand, when the input voltage of the charge circuit 20 changes to the pulsed state, and if the reduction time T1 of the input voltage of the charge circuit 20 is within the reduction time threshold value and the input voltage of the charge circuit 20, which has reduced, is lower than the lower limit threshold value, it is possible to determine that the voltage fluctuations have occurred in association with an anomaly of the charge circuit 20.

Under this circumstance, the microcomputer 50 can set the lower limit threshold value based on the battery rated voltage of the battery 45 among the charge conditions obtained from the charge condition acquisition bus 90. Incidentally, when setting the lower limit threshold value, the lower limit threshold value can be stored in advance, based on in the battery rated voltage of the battery 45, in a memory for the microcomputer 50. In this case, the charge condition acquisition bus 90 is not necessary.

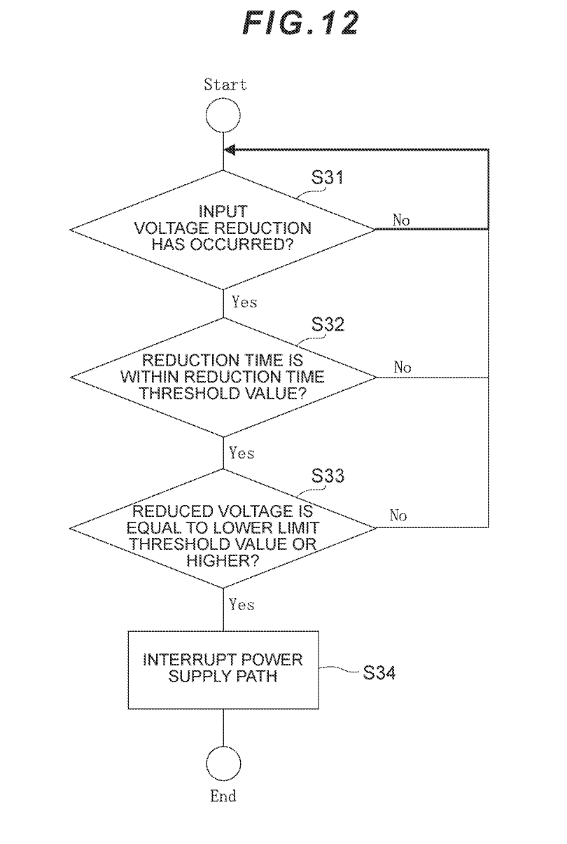

FIG. 12 is a flowchart for explaining processing of the microcomputer 50 according to the third embodiment of the present invention. This processing is executed by the CPU contained in the microcomputer 50. The microcomputer 50 inputs the voltage detected by the input voltage detection unit 51 from the input voltage detection unit 51 and judges whether the input voltage of the charge circuit 20 has decreased or not (S31). If the microcomputer 50 obtains a negative judgment result in step S31, it repeats the processing in step S31; and if the microcomputer 50 obtains an affirmative judgment result in step S31, it judges whether the reduction time T1 of the input voltage of the charge circuit 20 (see the input voltage reduction time T1 in FIG. 6) is within the reduction time threshold value or not (S32).

If the microcomputer 50 obtains a negative judgment result in step S32, it repeats the processing in steps S31 and S32; and if the microcomputer 50 obtains an affirmative judgment result in step S32, that is, if the input voltage of the charge circuit 20 fluctuates up and down or in a pulsed manner once, the microcomputer 50 judges whether the input voltage of the charge circuit 20, which has reduced, is equal to or more than the lower limit threshold value or not (S33).

If the microcomputer 50 obtains a negative judgment result in step S32, it returns to step S31 and repeats the processing in steps S31 and S32; and if the microcomputer 50 obtains an affirmative judgment result in step S33, that is, if it is determined that an anomaly such as a short fault has occurred at the charge circuit 20, then the microcomputer 50 turns off the N channel MOS-FET 52 and interrupts the power supply path 70 (S34), thereby terminating the processing in this routine.

In this embodiment, when a short fault has occurred at the charge circuit 20, for example, when a short fault which causes both ends of the N channel MOS-FET 23 to be connected has occurred, or when a short fault which causes short circuit of the power supply input terminal 30 and the power supply output terminal 31 has occurred, the N channel MOS-FET 52 is turned off and the power supply path 70 is interrupted even if the input voltage of the charge circuit 20 fluctuates up and down or in a pulsed manner once, and on condition that the reduction time T1 of the input voltage of the charge circuit 20 is within the reduction time threshold value and the input voltage of the charge circuit 20, which has reduced, is equal to or higher than the lower limit threshold value.

According to this embodiment, it is possible to prevent the voltage of the battery 45 from exceeding the rated voltage and also prevent the input voltage of the charge circuit 20 from fluctuating up and down or in a pulsed manner more than once. As a result, it is possible to protect the battery 45 when an anomaly of the charge circuit 20 occurs. Furthermore, the power supply path 70 is interrupted on condition that the reduction time T1 of the input voltage of the charge circuit 20 is within the reduction time threshold value and the input voltage of the charge circuit 20, which has reduced, is equal to or higher than the lower limit threshold value. So, it is possible to prevent the power supply path 70 from being mistakenly interrupted when the voltage of the DC power supply 10 itself fluctuates.

### Fourth Embodiment

This embodiment is designed to notify the user upon the occurrence of an anomaly of the charge circuit that the anomaly has occurred at the charge circuit.

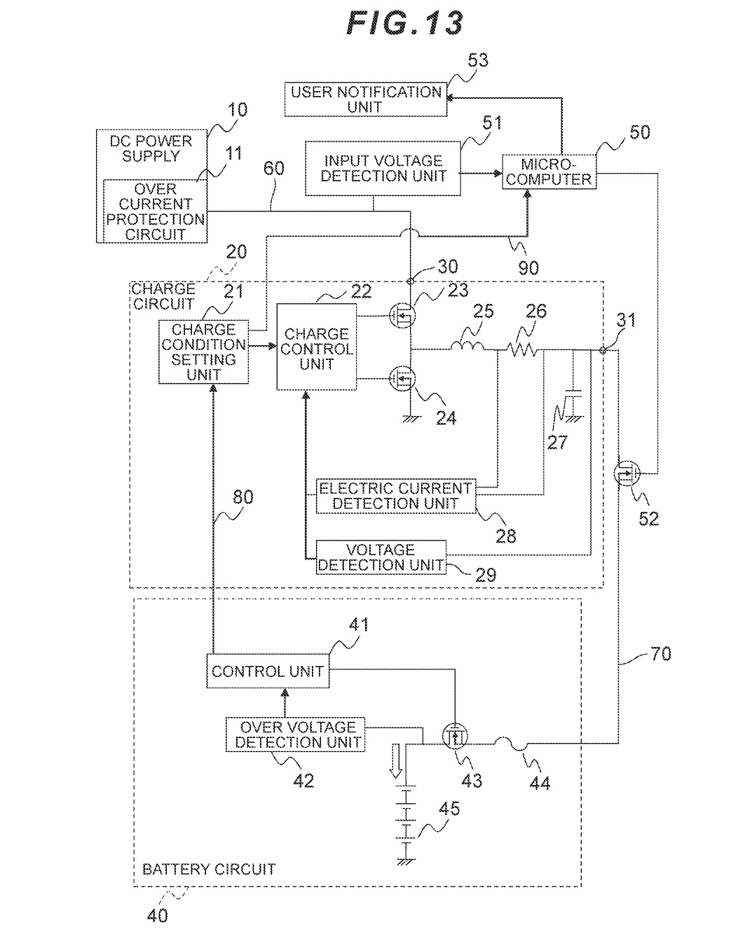

FIG. 13 is a configuration diagram of information equipment according to a fourth embodiment of the present invention. Referring to FIG. 13, the information equipment according to this embodiment is configured so that a user notification unit 53 is connected to an input/output interface of the microcomputer 50 and the microcomputer 50 outputs information to notify the user of the occurrence of an anomaly of the charge circuit 20 via the user notification unit 53 when the microcomputer 50 determines that the anomaly has occurred at the charge circuit 20; and other components are the same as those of the third embodiment.

Referring to FIG. 13, the user notification unit 53 is composed of, for example, a light emitting diode indicator or a buzzer. If the microcomputer 50 determines under this circumstance that an anomaly such as a short fault has occurred at the charge circuit 20, it outputs an anomaly detection signal to the user notification unit 53, thereby causing the light emitting diode indicator to light up or blink or causing the buzzer to ring. Incidentally, a display connected to the microcomputer 50 can be used as a user notification unit instead of the user notification unit 53. In this case, if the microcomputer 50 determines that an anomaly has occurred at the charge circuit 20, it can display information on a screen of the display to notify the user that the anomaly has occurred at the charge circuit 20.

When an anomaly has occurred at the charge circuit 20, it is possible according to this embodiment to draw the user's attention upon the occurrence of the anomaly at the charge circuit 20 by having the user notification unit 53 notify the user that the anomaly has occurred at the charge circuit 20. So, it is possible to construct safer information equipment

### Fifth Embodiment

This embodiment is designed to determine that an anomaly has occurred at the charge circuit 20, and interrupt the power supply path 60 on condition that the input voltage of the charge circuit 20 fluctuates up and down or in a pulsed manner once.

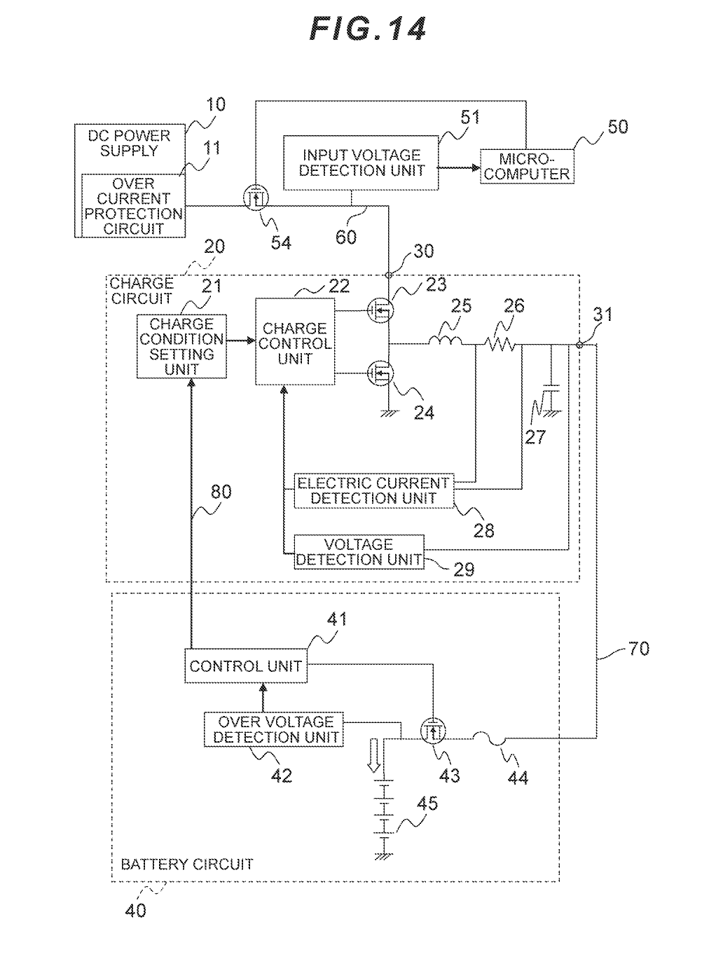

FIG. 14 is a configuration diagram of information equipment according to a fifth embodiment of the present invention. Referring to FIG. 14, the information equipment according to this embodiment is designed to insert an N channel MOS-FET 54 into the power supply circuit 60 connecting the DC power supply 10 and the charge circuit 20 instead of inserting the N channel MOS-FET 52 into the power supply circuit 70 connecting the charge circuit 20 and the battery circuit 40, and turn off the N channel MOS-FET 54 upon the occurrence of an anomaly of the charge circuit 20; and other components are the same as those of the first embodiment.

In this embodiment, when a short fault has occurred at the charge circuit 20, for example, when a short fault which causes both ends of the N channel MOS-FET 23 to be connected has occurred, or when a short fault which causes short circuit of the power supply input terminal 30 and the power supply output terminal 31 has occurred, the N channel MOS-FET 54 is turned off and the power supply path 60 is interrupted on condition that the input voltage of the charge circuit 20 fluctuates in a pulsed manner once and the reduction time T1 of the input voltage of the charge circuit 20 is within the reduction time threshold value.

According to this embodiment, it is possible to prevent the voltage of the battery 45 from exceeding the rated voltage and also prevent the input voltage of the charge circuit 20 from fluctuating up and down or in a pulsed manner more than once; and as a result, it is possible to protect the battery 45 when an anomaly of the charge circuit 20 has occurred. Furthermore, the power supply path 60 is interrupted on condition that the reduction time T1 of the input voltage of the charge circuit 20 is within the reduction time threshold value. So, it is possible to prevent the power supply path 60 from being mistakenly interrupted when the input voltage decreases in association with the attachment or detachment of the DC power supply 10.

Incidentally, the present invention is not limited to the aforementioned embodiments, and includes various variations. For example, the present invention is not necessarily limited to those having all the configurations explained above. Furthermore, part of the configuration of a certain embodiment can be replaced with the configuration of another embodiment and the configuration of another embodiment can be added to the configuration of a certain embodiment. Also, part of the configuration of each embodiment can be added to, or deleted from, or replaced with, the configuration of another configuration.

For example, the configuration is not limited to one with the N channel MOS-FET 54 located in the power supply path 60 or one with the N channel MOS-FET 52 located in the power supply path 70; and the N channel MOS-FET 54 can be located in the power supply path 60 and also the N channel MOS-FET 52 can be located in the power supply path 70, and each N channel MOS-FET 52, 54 can be interrupted when an anomaly of the charge circuit 20 has occurred. Furthermore, instead of using the microcomputer 50 as the interruption circuit and the information processing circuit, the interruption circuit for interrupting the N channel MOS-FET 52 or 54 upon the occurrence of an anomaly of the charge circuit 20 can be located separately from the microcomputer 50 and the microcomputer 50 can be used merely as the information processing circuit.

Furthermore, part or all of the aforementioned configurations, functions, circuits, and so on may be realized by hardware by, for example, designing them in integrated circuits. Also, each of the aforementioned configurations, functions, circuits, and so on may be realized by software by processors interpreting and executing programs for realizing each of the functions. Information such as programs, tables, and files for realizing each of the functions may be recorded and retained in memories, storage devices such as hard disks and SSDs (Solid State Drives), or storage media such as IC (Integrated Circuit) cards, SD (Secure Digital) memory cards, and DVDs (Digital Versatile Discs).

### REFERENCE SIGNS LIST

10 DC power supply, 11 over current protection circuit, 20 charge circuit, 21 charge condition setting unit, 22 charge control unit, 23, 24 N channel MOS-FET, 28 electric current detection unit, 29 voltage detection unit, 40 battery circuit, 41 control unit, 42 over voltage detection unit, 45 battery, 50 microcomputer, 51 input voltage detection unit, 52, 54 N channel MOS-FET, 53 user notification unit, 60, 70 power supply paths, 80 battery information acquisition bus, 90 charge condition acquisition bus.

1. Information equipment equipped with a DC power supply, a battery storing electric power from the DC power supply, and an information processing circuit for processing information, the information equipment comprising:
a charge circuit located between the DC power supply and the battery, for controlling an output voltage of the DC power supply and applying the controlled voltage to the battery;
a battery protection circuit for interrupting a first power supply path connecting the battery and the charge circuit when an anomaly of the battery occurs;
an input voltage detection circuit for detecting an input voltage which is input from the DC power supply to the charge circuit; and
an interruption circuit for determining that an anomaly of the charge circuit has occurred, and interrupting a second power supply path connecting the first power supply path or the DC power supply and the charge circuit when the input voltage detected by the input voltage detection circuit fluctuates and indicates an abnormal value.

2. The information equipment according to claim 1, wherein the interruption circuit interrupts the first power supply path or the second power supply path on condition that the input voltage detected by the input voltage detection circuit fluctuates up and down more than once.

3. The information equipment according to claim 1, wherein the interruption circuit interrupts the first power supply path or the second power supply path on condition that the input voltage detected by the input voltage detection circuit fluctuates up and down at least once and reduction time of the fluctuating input voltage is within a reduction time threshold value.

4. The information equipment according to claim 1, wherein the interruption circuit interrupts the first power supply path or the second power supply path on condition that the input voltage detected by the input voltage detection circuit fluctuates up and down at least once, reduction time of the fluctuating input voltage is within a reduction time threshold value, and the fluctuating input voltage which has reduced is equal to or higher than a lower limit threshold value.

5. The information equipment according to claim 1, further comprising a user notification unit for outputting information to notify a user of the occurrence of the anomaly of the charge circuit when the interruption circuit determines that the anomaly of the charge circuit has occurred.

6. A battery charge circuit for supplying electric power from a DC power supply to a battery, the battery charge circuit comprising:
a charge circuit located between the DC power supply and the battery, for controlling an output voltage of the DC power supply and applying the controlled voltage to the battery;
a battery protection circuit for interrupting a first power supply path connecting the battery and the charge circuit when an anomaly of the battery occurs;
an input voltage detection circuit for detecting an input voltage which is input from the DC power supply to the charge circuit; and
an interruption circuit for determining that an anomaly of the charge circuit has occurred, and interrupting a second power supply path connecting the first power supply path or the DC power supply and the charge circuit when the input voltage detected by the input voltage detection circuit fluctuates and indicates an abnormal value.

7. The battery charge circuit according to claim 6, wherein the interruption circuit interrupts the first power supply path or the second power supply path on condition that the input voltage detected by the input voltage detection circuit fluctuates up and down more than once.

8. The battery charge circuit according to claim 6, wherein the interruption circuit interrupts the first power supply path or the second power supply path on condition that the input voltage detected by the input voltage detection circuit fluctuates up and down at least once and reduction time of the fluctuating input voltage is within a reduction time threshold value.

9. The battery charge circuit according to claim 6, wherein the interruption circuit interrupts the first power supply path or the second power supply path on condition that the input voltage detected by the input voltage detection circuit fluctuates up and down at least once, reduction time of the fluctuating input voltage is within a reduction time threshold value, and the fluctuating input voltage which has reduced is equal to or higher than a lower limit threshold value.

10. The battery charge circuit according to claim 6, further comprising a user notification unit for outputting information to notify a user of the occurrence of the anomaly of the charge circuit when the interruption circuit determines that the anomaly of the charge circuit has occurred.

11. The information equipment according to claim 2, further comprising a user notification unit for outputting information to notify a user of the occurrence of the anomaly of the charge circuit when the interruption circuit determines that the anomaly of the charge circuit has occurred.

12. The information equipment according to claim 3, further comprising a user notification unit for outputting information to notify a user of the occurrence of the anomaly of the charge circuit when the interruption circuit determines that the anomaly of the charge circuit has occurred.

13. The information equipment according to claim 4, further comprising a user notification unit for outputting information to notify a user of the occurrence of the anomaly of the charge circuit when the interruption circuit determines that the anomaly of the charge circuit has occurred.

14. The battery charge circuit claim 7, further comprising a user notification unit for outputting information to notify a user of the occurrence of the anomaly of the charge circuit when the interruption circuit determines that the anomaly of the charge circuit has occurred.

15. The battery charge circuit claim 8, further comprising a user notification unit for outputting information to notify a user of the occurrence of the anomaly of the charge circuit when the interruption circuit determines that the anomaly of the charge circuit has occurred.

16. The battery charge circuit claim 9, further comprising a user notification unit for outputting information to notify a user of the occurrence of the anomaly of the charge circuit when the interruption circuit determines that the anomaly of the charge circuit has occurred.
